(19) United States
(12) Patent Application Publication
(10) Pub. No.: US 2026/0159645 A1
(43) Pub. Date: Jun. 11, 2026

(54) PROCESS FOR THE PRODUCTION OF A CARBONATE POLYESTER (CO)POLYMER

(71) Applicant: Avantium Knowledge Centre B.V., Amsterdam (NL)

(72) Inventors: Kevin van der Maas, Amsterdam (NL); Bing Wang, Amsterdam (NL); Robert-Jan Van Putten, Amsterdam (NL); Gerardus Johannes Maria Gruter, Amsterdam (NL)

(21) Appl. No.: 19/125,191

(22) PCT Filed: Dec. 19, 2023
(86) PCT No.: PCT/EP2023/086531

§ 371 Date: Apr. 28, 2025

(30) Foreign Application Priority Data
Dec. 20, 2022 (EP) 22214862.9

(51) Int. Cl. C08G 63/78; C08G 63/64

(52) U.S. Cl. CPC C08G 63/78; C08G 63/64

(57) ABSTRACT

The invention relates to a process for the production of a carbonate polyester (co)polymer which includes the use of bis(2-methoxyphenyl) carbonate to introduce carbonate monomer units into the polymer chain. The process is an efficient process for the production of novel and existing carbonate polyester (co)polymers, also with high molecular weight, and optionally without the need for the addition of a metal catalyst.

### FIELD OF THE INVENTION

The invention relates to a process for the production of a polyester (co)polymer comprising carbonate units, and to a polyester (co)polymer obtainable by, or obtained by, said process.

### BACKGROUND OF THE INVENTION

Currently, almost all plastics are still made of a fossil based feedstock. Only about 1% of the total plastics production relates to plastics obtained from a bio-based feedstock. In order to move to a more sustainable future, novel plastics should be developed which are produced from sustainable sources such as biomass, CO₂ or recycled content. To be able to fully replace fossil-based plastics, similar or preferably better material properties are needed. These include high glass transition temperature, good mechanical strength and barrier properties. Furthermore, to make it economically viable, the polymer production process should be energy-efficient and scalable. In addition, many of the plastics used today show very limited to no degradation, for most it can even take hundreds of years. Today, plastic can be almost found everywhere in the environment, it is found in sea water, freshwater, food and even drinking water. This has many already noticeable harmful effects to our health and environment, and many potentially harmful effects are under investigation. Despite the fact that plastic should not be spilled into the environment and build-up should be minimized by proper disposal and public awareness, with as main goal reuse and recycling, it appears to be unavoidable that there will always be leakage into the environment. Therefore, when developing novel plastics it is important to take into account the lifetime expectancy of the application of the product. The plastic should be durable throughout its use, and should have some degree of degradability after use to prevent environmental build-up when the plastic finds its fate in nature.

There is a need for bio-based and potentially more biodegradable polyesters, which for example might be produced when using isosorbide as monomer units. This building block has the potential to be readily obtained from renewable resources. Isosorbide is a rigid, chiral and non-toxic molecule containing two hydroxyl groups, a biobased chemical which can be obtained from glucose via the dehydration of sorbitol. It is available on large scale with an annual production capacity of 20,000 kiloton (2015). When incorporated in polymers, isosorbide enhances the thermomechanical stability, provides good mechanical properties, and gives non-toxic degradation products. Therefore, it has great potential to be used as building block in polyesters.

One of the most important goals of new polymerization processes is to obtain polymers with a molecular weight high enough for the desired application(s). This is important as the molecular weight of the polymer relates to polymer performance e.g., strength, toughness and durability. The use of polymers with insufficient molecular weight may lead to application failures. Therefore, many studies concerning polymerization processes and the conditions used in those processes relate to realizing the target (high) molecular weight.

Polyesterification is a reversible polymerization reaction with a relatively low equilibrium constant, which means that removal of the condensation product(s) has an impact on the molecular weight that can be achieved. Melt polycondensation at reduced pressure is commonly used in polyesterification processes for removal of the condensation product(s). However, the increase of molecular weight of the polymers during that process also increases the viscosity of the melt material, which complicates the removal of condensation product(s). This may eventually become a limiting factor. Removal of condensation product(s) can be improved, for example by using higher temperatures, longer reaction times, catalysts and improved reactor designs. However, under melt conditions, limited mass transfer due to high viscosity of the melt material, in combination with longer residence times and (potential) chemical degradation, may limit the possibilities to obtain higher molecular weights. In order to obtain high molecular weights, an additional solid-state polymerization (SSP) step may be required. In SSP, polymer pellets are heated below the melting point while being rotated under a nitrogen flow or vacuum. A drawback of SSP is that due to the low mobility of the end groups and condensate in the solid state, this is time and energy consuming, and therefore an expensive process.

When less reactive diols such as isosorbide are used in polyesterification, it is difficult to obtain sufficiently high molecular weights. As discussed, incorporation of isosorbide is interesting due to its additional benefits on thermomechanical stability and mechanical performance, which opens new possibilities for applications. Isosorbide is, however, less reactive due to its secondary alcohol groups, and melt polycondensation becomes considerably more difficult with increasing isosorbide content. Furthermore, the crystallinity of the polymer is lost with isosorbide contents above around 15%, which makes it impossible to use SSP, as an amorphous polymer would clump together. Thus, the option to use SSP to increase the molecular weight is not available with higher isosorbide content.

Therefore, there is a need for an improved and efficient process for the production of polyesters with a high molecular weight, especially with high isosorbide content, the process preferably to be performed at mild conditions, such as relatively low temperatures and relatively short reaction times. Further, the use/presence of toxic components such as phenol should be avoided, and solid-state polymerization for obtaining high molecular weights should not necessarily be required.

### SUMMARY OF THE INVENTION

According to the present invention, such an improved process is provided. The present invention relates to a process for the production of a carbonate polyester (co)polymer, comprising the use of bis(2-methoxyphenyl) carbonate to introduce carbonate monomer units into the polymer chain, said process comprising at least steps (a) and (b):
(a) an esterification/transesterification step wherein at least one dicarboxylic acid or an ester derivative thereof is/are reacted with an excess of at least one diol compound to form a pre-polycondensation product having predominantly alcohol end groups, or otherwise producing such pre-polycondensation product;
(b) a polymerization step comprising polycondensation of the product of step (a) with bis(2-methoxyphenyl) carbonate in a molar amount of at most 0.5 equivalents of the molar amount of alcohol end groups in the pre-polycondensation product of step (a).

Advantageously, it is very favorable to use bis(2-methoxyphenyl) carbonate for the production of a carbonate polyester (co)polymer, as the inventors have found that the 2-methoxyphenyl group (also referred to as guaiacyl group) has exceptional leaving group properties in condensation reactions. Consequently, the high reactivity of the bis(2-methoxyphenyl) carbonate ester allows performing reactions at relatively low temperatures and provides flexibility in its use in polymerization processes.

A wide range of carbonate containing polyester (co)polymers may conveniently be produced using the bis(2-methoxyphenyl) carbonate ester of the present invention. An advantageous process is provided herewith for the preparation of both existing and, in particular, also novel polyester (co)polymers with favorable properties. In addition, relatively high number average molecular weights of the polyester (co)polymer end product may be obtained due to the high reactivity of the bis(2-methoxyphenyl) carbonate ester.

Thus, as a further aspect, the invention relates to certain novel carbonate containing polyester (co)polymers, and optionally also to novel (co)polymers that were produced without addition of a metal catalyst.

In addition, the invention provides a composition comprising any one of said novel polyester (co)polymers and in addition one or more additives and/or one or more additional polymers.

Further, the invention provides an article comprising the polyester (co)polymer according to the present invention or a composition comprising said polyester (co)polymer and one or more additives and/or additional (co)polymers.

The polyester (co)polymers and/or compositions produced according to the invention can advantageously be used in a broad range of (industrial) applications, such as in fibres, injection (blow) moulded parts and bottles, 3D printing, packaging materials, etc.

### DETAILED DESCRIPTION OF THE INVENTION

The present invention relates to an improved process for the production of carbonate polyester (co)polymers.

The disclosure relates to a process comprising the use of diphenyl carbonate or bis(2-methoxyphenyl) carbonate to introduce carbonate monomer units into the polymer chain, comprising at least steps (a) and (b):
(a) an esterification/transesterification step wherein at least one dicarboxylic acid or an ester derivative thereof is/are reacted with an excess of at least one diol compound to form a pre-polycondensation product having predominantly alcohol end groups, or otherwise producing such pre- polycondensation product;
   (b) a polymerization step comprising polycondensation of the product of step (a) with diphenyl carbonate or bis(2-methoxyphenyl) carbonate in a molar amount of at most 0.5 equivalents of the molar amount of alcohol end groups in the pre-polycondensation product of step (a). According to the invention, bis(2-methoxyphenyl) carbonate is used in the process,

The “excess” used in step (a) herein in particular means a ratio 1:0.95 to 1:0.5 of total moles of diol compounds to total moles of diacid compounds (i.e. dicarboxylic acids or an ester derivative(s) thereof).

By a “polyester” herein is understood a polymer comprising a plurality of monomer units linked via ester functional groups in its main chain. An ester functional group can be formed by reacting a hydroxyl group (—OH) with a carboxyl/carboxylic acid group (—C(═O)OH). Typically, a polyester is a synthetic polymer formed by the reaction of one or more bifunctional carboxylic acids with one or more bifunctional hydroxyl compounds. Polyesters may also comprise units derived from monomers carrying both a hydroxyl group and a carboxylic acid group, such as polylactic acid (PLA), polyglycolic acid (PGA), poly(lactic-co-glycolic acid) (PLGA), polyhydroxyalkanoates (PHA), and the like. By a “polyester copolymer” is herein understood a polyester wherein three or more types of monomer units are joined in the same polymer main chain.

By a “monomer unit” is herein understood a unit as included in a polyester copolymer or oligomer, which unit can be obtained after polymerization of a monomer, that is, a “monomer unit” is a constitutional unit contributed by a single monomer or monomer compound to the structure of the polymer or oligomer, herein in particular the smallest diol or di-acid repeating unit.

By a “monomer” or “monomer compound” is herein understood the smallest building block used as the starting compound to be polymerized, such as a diol or di-acid compound, but also a hydroxycarboxylic acid.

By an “oligomer” or “oligomer compound” is herein understood a molecular structure comprising an in total average number of monomer units of in the range from equal to or more than 2 to equal to or less than 25 monomer units. Next to diol and di-acid derived monomer units, also other monomer units may be part of the oligomer, such as hydroxycarboxylic acid derived monomer units, in particular derived from α-hydroxycarboxylic acids, such as glycolic acid, lactic acid, mandelic acid, 3-alkoxy carbonic acid, and the like.

By the wording “pre-polycondensation product” is herein understood a polymer of limited chain length that can be used as starting polymeric material for carbonate insertion. Such pre-polycondensation product can be obtained by the esterification/transesterification step defined in step (a), but such pre-polycondensation products may also result from other processes, which may be performed separately, even in a different reactor. For example, suitable pre-polycondensation products may be terephthalate oligomers with alcohol end groups, e.g. produced by recycling processes, such as PET glycolysis products, including bis(2-hydroxyethyl) terephthalate, and higher PET oligomers (see e.g. T. Spychaj in “Handbook of thermoplastic polymers”, 2002 Wiley, Chapter 27, p 1259-61).

By the wording “otherwise producing such pre-polycondensation product” is herein understood as processes as described above that result in pre-polycondensation conducts similar as the ones obtained in step (a).

A “pre-polycondensation product having predominantly alcohol end groups” herein specifically means that in the pre-polycondensation product the alcohol to acid end group ratio is at least 95:5.

The present process relates to the production of a carbonate polyester (co)polymer, comprising at least steps (a) and (b), wherein in the polymerization step (b) carbonate monomer units are introduced into the polymer chain by using the bis(2-methoxyphenyl) carbonate ester. In the prior art, diphenyl carbonate has been described as a constitutive component in a melt polycondensation process forming a polyester product comprising isosorbide and carbonate units. See e.g. US2016/0152767, wherein a dicarboxylic acid diester is reacted in a one-pot process with isosorbide and diphenyl carbonate. However, the advantageous two-step process according to the present invention involving the use of diphenyl carbonate or in particular the bis(2-methoxyphenyl) carbonate ester, with its favorable leaving group properties, has not been described or suggested.

Guaiacol (2-methoxyphenol), which is produced as a side product in the present process, is considerably less toxic than phenol, which is produced when the diphenyl carbonate ester is used. Furthermore, guaiacol can be sourced from the abundantly available renewable lignin. The inventors have found that diguaiacyl carbonate is significantly more reactive than diphenyl carbonate in certain condensation reactions, in certain situations advantageously requiring reduced polymerization times and temperatures, and also resulting in higher molecular weights of the products.

Furthermore, the presently claimed process advantageously allows in step (a) an esterification/transesterification step wherein at least one dicarboxylic acid is reacted directly with an excess of at least one diol compound, without the need to first form a diester of said dicarboxylic acid in a separate reaction step. In contrast, in a process in which also the carbonate compound would be present in one pot with dicarboxylic acid and a diol, water would be formed as a condensation product, which however would react with the carbonate to form carbonic acid. Advantageously, by first producing a pre-polycondensation product comprising alcohol end groups, followed by a polycondensation step with bis(2-methoxyphenyl) carbonate, a carbonate-containing polymer can be produced in an efficient, commercially attractive manner, with tunable amounts of carbonate units.

The dicarboxylic acid or ester derivative thereof and the diol compound in step (a) can be any suitable diacid and any suitable diol known for polyester preparation. A person skilled in the art will understand what starting materials to select for the desired carbonate polyester (co)polymer product. Preferred dicarboxylic acids comprise aromatic dicarboxylic acids, heteroaromatic dicarboxylic acids, 1,4-cyclohexanedicarboxylic acid, diglycolic acid and C2-C18 aliphatic dicarboxylic acids which may be linear, cyclic or branched, in particular linear dicarboxylic acids of the formula HOOC(CH₂)ₙCOOH, wherein n is an integer of 0 to 20. In a preferred embodiment, step (a) of the process comprises reacting a dicarboxylic acid selected from succinic acid, adipic acid, 2,5-furandicarboxylic acid or terephthalic acid, or an ester derivative of any one of said acids (wherein diguaiacyl ester derivatives may be preferred), especially selected from succinic acid, adipic acid, 2,5-furandicarboxylic acid or terephthalic acid (of which succinic acid is preferred), with a diol, preferably with isosorbide (a 1,4:3,6-dianhydrohexitol) and optionally another diol. Especially preferred are processes wherein poly (succinate (co)carbonate) copolymers are formed, thus wherein succinic acid is used in step (a), which allows reducing the amount of bis(2-methoxyphenyl) carbonate needed in step (b), and thereby less of the corresponding alcohol is produced. Poly(succinate (co)carbonate) copolymers have properties similar to polycarbonates with very high carbonate content (like DURABIO™). In a preferred embodiment, the process comprises reacting succinic acid and isosorbide in step (a) to form isosorbide succinate oligomers having predominantly alcohol end groups, wherein preferably the ratio of isosorbide to succinic acid is in the range of 1:0.95 to 1:0.5.

Instead of isosorbide, or in combination with isosorbide, suitably also other secondary diols may be selected from cyclic or non-cyclic, preferably aliphatic, diols, especially from other 1,4:3,6-dianhydrohexitols, and from cis- and/or trans-2,2,4,4-tetramethyl-1,3-cyclobutanediol. Said other optional other diol (i.e. the diol used in addition to isosorbide or other secondary diol) preferably is a linear aliphatic diol, preferably selected from 1,3-propanediol, 1,4-butanediol, 1,5-pentanediol, 1,6-hexanediol, 1,4-cyclohexanedimethanol, neopentylglycol and diethyleneglycol.

The diol in step (a) of the process of this invention may in fact be any suitable diol and may be selected from primary and secondary diols (for the latter vide supra). Suitably, in the case of primary diols, any primary diol is selected from C2-C18 aliphatic diols, in particular from linear, cyclic or branched, saturated C2-C12 aliphatic diol compounds, and preferably from ethylene glycol, 1,3-propanediol, 1,4-butanediol, 1,5-pentanediol, 1,6-hexanediol, diethyleneglycol, neopentylglycol, 1,4-cyclohexanedimethanol, and acetals of polyols.

Interesting carbonate (co)polymer compounds can be prepared by the process according to the present invention, especially when the at least one diol is isosorbide, thereby producing polyester (co)polymers at least comprising isosorbide and carbonate units. The present two-step procedure allows easy incorporation of different contents of carbonate, e.g. by varying the chosen length of the pre-polycondensation product in step (a). Consequently, for example thermal properties of the carbonate (co)polymers can effectively be tuned by carefully selecting the type of monomer units to be built into the polymer structure and by varying the amount of carbonate.

The diol compound in the two-step process described herein above may also be an oligomer with alcohol functionalities. In an embodiment, the diol compound is bis(2-hydroxyethyl) terephthalate, when a therephthalate polyester is the desired end product. Suitably, such process may comprise reacting bis(2-hydroxyethyl) terephthalate and terephthalic acid in step (a) to form ethylene terephthalate oligomers comprising alcohol end groups.

In an embodiment, the process of this invention comprises reacting (the recycling product) bis(2-hydroxyethyl) terephthalate directly with bis(2-methoxyphenyl) carbonate to form polyethylene terephthalate carbonate polyester (co)polymers. Thus, in step (a) bis(2-hydroxyethyl) terephthalate is produced as pre-polycondensation product, which in step (b) is polymerized by polycondensation with bis(2-methoxyphenyl) carbonate to form a polyethylene terephthalate carbonate copolyester.

The currently claimed process, using the highly reactive bis(2-methoxyphenyl) carbonate, has demonstrated to solve problems previously encountered with the low reactivity of isosorbide. High yields are obtained, and there is no need for compensation of any diol losses, as full incorporation is observed of the isosorbide used in the feed. The increased reactivity of the bis(2-methoxyphenyl) carbonate allows to select polymerization conditions relatively mild and reaction times relatively short, even when no catalyst is added. The process of this invention is therefore preferable for the production of polycarbonates from isosorbide with high molecular weights, which is also applicable for larger scales.

The process of the invention advantageously comprises adding in step (a) a monohydric alcohol (solvent) with a boiling point at ambient pressure of equal to or higher than 175° C. up to equal to or lower than 300° C. and an acid dissociation constant (pKa), determined in water at 25° C., of equal to or less than 12.0 and equal to or more than 7.0, in an amount of 2.5-100 weight % with regard to the total weight of all dicarboxylic acids or ester derivatives thereof and diol compounds together. This has a facilitating effect in the process to produce high molecular weight polyester (co)polymers, which effect is unexpected, as for example mono-alcohols are known to be “terminators” in certain polymerization reactions, sealing the ends of growing polymeric chains. In the monohydric alcohol the hydroxy group is the only reactive functional group. The amount of the alcohol used is preferably 5 to 95 weight %, more preferred 10 to 90 weight %, and particularly 25 to 85 weight %. In particular, the alcohol is an optionally substituted phenol, in particular selected from phenol, 4-methylphenol, 4-ethylphenol, 2-methoxyphenol (guaiacol), 4-methoxyphenol, 4-ethyl-2-methoxyphenol, 4-chlorophenol, and any combination thereof. A highly preferred monohydric alcohol is 2-methoxyphenol. The monohydric alcohol may serve as a reactive diluent in the reaction mixture, which may be desirable or considered necessary under certain circumstances. If deemed suitable, in addition to the monohydric alcohol, also an inert solvent, in particular diphenyl ether, dimethoxybenzene, etc., may be added to the reaction. Advantageously, when using monohydric alcohol in the presently claimed process, and when compared to polymerization techniques known in the art which start from a mixture of monomers, less of certain compounds are lost during polymerization. Preferably, the process comprises adding the monohydric alcohol in step (a). For example, more isosorbide and/or succinic acid, respectively, may be incorporated into resulting polyester (co)polymers when a monohydric alcohol is used in step (a) of the process.

The process of the invention may be performed in the presence or absence of (trans)esterification/polycondensation catalysts. Therefore, another embodiment relates to the process according to this invention, comprising the use of a catalyst, preferably a metal-containing catalyst. The catalyst preferably is used in amounts from 0.01 mole % to 0.5 mole % with regard to the total amount of monomers (in moles). Such metal-containing catalyst may for example comprise derivatives of tin (Sn), titanium (Ti), zirconium (Zr), germanium (Ge), antimony (Sb), bismuth (Bi), hafnium (Hf), magnesium (Mg), cerium (Ce), zinc (Zn), cobalt (Co), iron (Fe), manganese (Mn), calcium (Ca), strontium (Sr), sodium (Na), lead (Pb), potassium (K), aluminium (Al), and/or lithium (Li). Examples of suitable metal-containing catalysts include salts of Li, Ca, Mg, Mn, Zn, Pb, Sb, Sn, Ge, and Ti, such as acetate salts and oxides, including glycol adducts, and Ti-alkoxides. Preferably the metal-containing catalyst is a tin-containing catalyst, for example a tin(IV)- or tin(II)-containing catalyst. More preferably the metal-containing catalyst is an alkyltin(IV) salt and/or alkyltin(II) salt. Examples include alkyltin(IV) salts, alkyltin(II) salts, dialkyltin(IV) salts, dialkyltin(II) salts, trialkyltin(IV) salts, trialkyltin(II) salts or a mixture of one or more of these. These tin(IV) and/or tin(II) catalysts may be used with alternative or additional metal-containing catalysts. A preferred metal-containing catalyst is n-butyltinhydroxide oxide.

Favorably, in another embodiment, the process according to the invention may be performed in the absence of a metal catalyst. Surprisingly, even when no metal catalyst is added in that process, high molecular weight polyester (co)polymers can be obtained.

The absence of a metal catalyst in the preparation of polyesters is most interesting from a sustainability and toxicity point of view. If such metal catalyst free polymers might find their fate in nature, or would be composted, no metal catalyst buildup or pollution of the metal salts in the environment would result. The absence of metal catalyst is also valuable for food and medical applications, where leaching of the catalyst could be a serious concern. In addition, also depletion of natural resources is becoming problematic: since efficient removal of low amounts of metal catalyst (typically used in polyester synthesis) from waste plastics is almost impossible, depletion of rare metal reserves is a consequence of the use of such catalysts. This already is a big concern for antimony, which in fact is the preferred metal in PET catalysis.

The process according to the invention can be carried out in a batch-wise, semi-batchwise or continuous mode. If applicable, the esterification/transesterification stage and the polycondensation stage may conveniently be carried out in one and the same reactor, but may also be carried out in two separate reactors, for example where the esterification/transesterification stage is carried out in a first esterification/transesterification reactor and the polycondensation stage is carried out in a second polycondensation reactor.

In any introduction stage the monomers may be introduced into the reactor simultaneously, for example in the form of a feed mixture, or in separate parts. The monomers may be introduced into the reactor in a molten phase or they can be molten and mixed after introduction into the reactor.

The (trans)esterification stage is performed according to procedures known in the art, but is preferably carried out in a reaction time in the range from equal to or more than 0.5 hour, more preferably equal to or more than 1.0 hour, to equal to or less than 20.0 hour, preferably to equal to or less than 10 hours, more preferably equal to or less than 6.0 hour. During a (trans)esterification stage, the temperature may be stepwise or gradually increased. The esterification/transesterification stage is preferably carried out under an inert gas atmosphere, suitably at ambient pressure or slightly above that, e.g. up to 5 bar.

The polycondensation stage is performed according to procedures known in the art, but is preferably carried out in a reaction time in the range from equal to or more than 0.5 hour, more preferably equal to or more than 1.0 hour, to equal to or less than 8.0 hours, more preferably equal to or less than 6.0 hours. During a polycondensation stage, the temperature may be stepwise or gradually increased. The polycondensation may suitably be carried out at a temperature equal to or higher or a bit lower than the temperature at which the (trans)esterification stage is carried out depending on the type of polyester (co)polymers. The (trans)esterification stage may for example be carried out at a temperature in the range from equal to or higher than 170° C., and depending on the desired polyester (co)polymer (e.g. high Tg polymers) preferably equal to or higher than 210° C., and even more preferably equal to or higher than 230° C., to equal to or lower than 260° C. Suitably, the polycondensation stage is carried out at reduced pressure.

The process according to the invention may optionally further comprise, in case the polymer is semi-crystalline, after a recovery stage (i.e. wherein the polyester (co)polymer is recovered from the reactor), a stage of polymerization in the solid state. That is, the polyester (co)polymer may be polymerized further in the solid state, thereby increasing chain length. Such polymerization in the solid state is also referred to as a solid state polymerization (SSP). Such a solid state polymerization may allow to further increase the number average molecular weight of the polyester (co)polymer. If applicable, SSP can further advantageously enhance the mechanical and rheological properties of polyester copolymers before injection blow molding or extruding. The solid state polymerization process preferably comprises heating the polyester (co)polymer in the essential or complete absence of oxygen and water, for example by means of a vacuum or purging with an inert gas. Generally, solid state polymerization may suitably be carried out at a temperature in the range from equal to or more than 150° C. to equal to or less than 220° C., at ambient pressure (i.e. 1.0 bar atmosphere corresponding to 0.1 MegaPascal) whilst purging with a flow of an inert gas (such as for example nitrogen or argon) or at reduced pressure, for example a pressure equal to or below 100 millibar (corresponding to 0.01 MegaPascal). The solid state polymerization may for example be carried out for a period in the range from equal to or more than 2 hours to equal to or less than 60 hours. The duration of the solid state polymerization may be tuned such that a desired final number average molecular weight for the polyester copolymer is reached.

The process according to the invention may be carried out in the presence of one or more additives, such as stabilizers, for example light stabilizers, UV stabilizers and heat stabilizers, fluidifying agents, flame retardants, ether formation suppressants and antistatic agents. Phosphoric acid is an example of a stabilizer applied in PET. Additives may be added at the start of the process, or during or after the polymerization reaction. Other additives include primary and/or secondary antioxidants. A primary antioxidant can for example be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox®1010 or Irganox®1076. A secondary antioxidant can for example be a trivalent phosphorous-comprising compounds, such as Ultranox® 626, Doverphos® S-9228 or Sandostab® P-EPQ.

In a further aspect, the invention relates to new (co)polyesters obtainable by, or obtained by, the currently claimed process. The process allows the preparation of a range of existing and novel polyester (co)polymers, often with high molecular weights that conventionally would not be obtainable. In another preferred embodiment no catalyst is used in the entire process, allowing the production of metal catalyst free polyester (co)polymers, that may be advantageous for certain uses requiring the absence of any catalyst, such as medical uses of polyesters. Thus, in an embodiment, preferably the (novel) polyester (co)polymer that is produced is a metal catalyst free (meaning: no metals present above ICP detection levels, i.e. less than 1 ppm metals present) polyester (co)polymer, i.e. which was produced without addition of a metal catalyst.

The (co)polyesters obtainable by the process according to the invention preferably have a glass transition temperature equal to or higher than 90° C., more preferably equal to or higher than 100° C.

Preferred polyester copolymers, optionally metal catalyst free, are selected from:
poly(isosorbide succinate co-carbonate),
poly(isosorbide co-1,3-propylene succinate co-carbonate),
poly(isosorbide co-1,4-butylene succinate co-carbonate),
poly(isosorbide co-cyclohexanedimethylene succinate co-carbonate), and
poly(isosorbide co-diethyleneglycol succinate co-carbonate),
   preferably with a glass transition temperature equal to or higher than 90° C.

More preferred copolymers of the invention have a glass transition temperature equal to or higher than 100° C. Further preferred copolymers have a high oxygen barrier. Particularly interesting copolymers of the invention have favourable mechanical properties, with tensile strengths of 50 to 90 MPa and/or Young's modulus of 2 to 5 GPa.

The amounts of each of the different monomeric units in the polyester (co)polymer often can be determined by proton nuclear magnetic resonance (¹H NMR). One skilled in the art would easily find the conditions of analysis to determine the amount of each of the different monomer units in the polyester (co)polymer. Other analysis methods can include depolymerization, followed by monomer quantification (versus standards). Polyesters can be depolymerized in water (hydrolysis), in alcohol, e.g. methanol (alcoholysis, e.g. methanolysis) or in glycol (glycolysis). An excess of depolymerization solvent ensures full depolymerization and a catalyst (e.g. a base) can accelerate the depolymerization.

The number average molecular weight (Mn) of the polyester (co)polymer(s) may vary and may depend for example on the added monomer type and amount, the presence or absence of a catalyst, the type and amount of catalyst, the reaction time and reaction temperature and pressure. Advantageously, the number average molecular weight of the polyester copolymer(s) according to the invention is at least 10000 grams/mole and preferably the number average molecular weight is equal to or more than 15000 grams/mole, particularly equal to or more than 18000 grams/mole, more preferably of equal to or more than 20000 grams/mole up to as high as 100000 grams/mole.

The weight average molecular weight (Mw) and the number average molecular weight (Mn) can be determined by means of gel permeation chromatography (GPC) at 35° C., using for the calculation poly(methyl methacrylate) (PMMA) as reference material using hexafluoro-2-propanol as eluent, or polystyrene (PS) standards as reference material and or dichloromethane as eluent, respectively. The combination of PMMA with hexafluoro-2-propanol is used when aromatic diacid or heteroaromatic diacid derived monomer units are present in the (co)polymer, and the combination PS and dichloromethane is used when aliphatic diacid monomer units are present in the (co)polymer. All molecular weights herein are determined as described under the analytical methods section of the examples.

Suitably the polyester (co)polymer according to the present invention may have a polydispersity index (that is, the ratio of weight average molecular weight (Mw) to number average molecular weight (Mn), i.e. Mw/Mn) in the range from equal to or higher than 1.4 to equal to or lower than 2.8, in particular from equal to or higher than 1.5 to equal to or lower than 2.6.

The glass transition temperature (Tg) of the polyester copolymer can be measured by conventional methods, in particular by using differential scanning calorimetry (DSC) with a heating rate of 10° C./minute in a nitrogen atmosphere. All glass transition temperatures herein are determined as described under the analytical methods section of the examples.

The process of the invention provides the person skilled in the art with tools and options to tune the desired properties of the polyester (co)polymers. For example, depending on the desired application, specific polyester (co)polymers may be made which provide a desired high oxygen barrier, which is potentially interesting for coating and packaging with diminished environmental impact. Further, carbonate polyester (co)polymers prepared according to the invention may have high Tg, which may be exploited for several applications, e.g. for hygienic reasons in the food or medical sector, such as hot filling and sterilizing. Also good mechanical properties were observed (e.g. tensile strength 74-77 MPa and Young's modulus of 3.6 GPa for PISC50, wherein the number indicates the carbonate content), which make the polyester (co)polymers interesting many types of applications.

The polyester (co)polymer obtainable by or obtained by the process of the invention can suitably be combined with additives and/or other (co)polymers and therefore the invention further provides a composition comprising said polyester (co)polymer and in addition one or more additives and/or one or more additional other (co)polymers.

Such composition can for example comprise, as additive, nucleating agents. These nucleating agents can be organic or inorganic in nature. Examples of nucleating agents are talc, calcium silicate, sodium benzoate, calcium titanate, boron nitride, zinc salts, porphyrins, chlorin and phlorin.

The composition according to the invention can also comprise, as additive, nanometric (i.e. having particles of a nanometric size) or non-nanometric and functionalized or non-functionalized fillers or fibres of organic or inorganic nature. They can be silicas, zeolites, glass fibres or beads, clays, mica, titanates, silicates, graphite, calcium carbonate, carbon nanotubes, wood fibres, carbon fibres, polymer fibres, proteins, cellulose fibres, lignocellulose fibres and nondestructured granular starch. These fillers or fibres can make it possible to improve the hardness, the stiffness or the permeability to water or to gases. The composition can comprise from 0.1% to 75% by weight, for example from 0.5% to 50% by weight, of fillers and/or fibres, with respect to the total weight of the composition. The composition can also be of composite type, that is to say can comprise large amounts of these fillers and/or fibres.

The composition can also comprise, as additive, opacifying agents, dyes and pigments. They can be chosen from cobalt acetate and the following compounds: HS-325 Sandoplast® Red BB, which is a compound carrying an azo functional group also known under the name Solvent Red 195, HS-510 Sandoplast® Blue 2B, which is an anthraquinone, Polysynthren® Blue R and Clariant® RSB Violet.

The composition can also comprise, as additive, a processing aid for reducing the pressure in the processing device. A mould-release agent, which makes it possible to reduce the adhesion to the equipment for shaping the polyester, such as the moulds or the rollers of calendering devices, can also be used. These agents can be selected from fatty acid esters and amides, metal salts, soaps, paraffins or hydrocarbon waxes. Specific examples of these agents are zinc stearate, calcium stearate, aluminium stearate, stearamide, erucamide, behenamide, beeswax or Candelilla wax.

The composition can also comprise other additives, such as stabilizers, etc. as mentioned herein above.

In addition, the composition can comprise one or more additional polymers other than the one or more polyester (co)polymers according to the invention. Such additional polymer(s) can suitably be chosen from the group consisting of polyamides, polystyrene, styrene copolymers, styrene/acrylonitrile copolymers, styrene/acrylonitrile/butadiene copolymers, polymethyl methacrylates, acrylic copolymers, poly(ether/imide)s, polyphenylene oxides, such as poly(2,6-dimethylphenylene oxide), polyphenylene sulfide, poly(ester/carbonate)s, polycarbonates, polysulphones, polysulphone ethers, polyetherketones and blends of these polymers.

The composition can also comprise, as additional polymer, a polymer which makes it possible to improve the impact properties of the polymer, in particular functional polyolefins, such as functionalized polymers and copolymers of ethylene or propylene, core/shell copolymers or block copolymers.

The compositions according to the invention can also comprise, as additional polymer(s), polymers of natural origin, such as starch, cellulose, chitosans, alginates, proteins, such as gluten, pea proteins, casein, collagen, gelatin or lignin, it being possible or not for these polymers of natural origin to be physically or chemically modified. The starch can be used in the destructured or plasticized form. In the latter case, the plasticizer can be water or a polyol, in particular glycerol, polyglycerol, isosorbide, sorbitans, sorbitol, mannitol or also urea. Use may in particular be made, in order to prepare the composition, of the process described in the document WO 2010/010282A1.

These compositions can suitably be manufactured by conventional methods for the conversion of thermoplastics. These conventional methods may comprise at least one stage of melt or softened blending of the polymers and one stage of recovery of the composition.

Such blending can for example be carried out in internal blade or rotor mixers, an external mixer, or single-screw or co-rotating or counter-rotating twin-screw extruders. However, it is preferred to carry out this blending by extrusion, in particular by using a co-rotating extruder. The blending of the constituents of the composition is preferably done under an inert atmosphere, and can suitably be carried out at elevated temperature. In the case of an extruder, the various constituents of the composition can suitably be introduced using introduction hoppers located along the extruder.

The invention also relates to an article, comprising a polyester (co)polymer according to the invention or a composition comprising a polyester (co)polymer according to the invention, and one or more additives and/or additional polymers. The polyester (co)polymer may conveniently be used in the manufacturing of films, fibres, injection moulded parts and packaging materials, such as for example receptacles. The use of the polyester (co)polymer is especially advantageous where such films, fibres, injection moulded parts or packaging materials need to be heat-resistant or cold-resistant.

The article can also be a fibre for use in for example the textile industry. These fibres can be woven, in order to form fabrics, or also nonwoven.

The article can also be a film or a sheet. These films or sheets can be manufactured by calendering, cast film extrusion or film blowing extrusion techniques. These films can be used for the manufacture of labels or insulators.

This article can be a receptacle especially for use for hot filling and reuse applications. This article can be manufactured from the polyester (co)polymer or a composition comprising a polyester (co)polymer and one or more additives and/or additional polymers using conventional conversion techniques. The article can also be a receptacle for transporting gases, liquids and/or solids. The receptacles concerned may be baby's bottles, flasks, bottles, for example sparkling or still water bottles, juice bottles, soda bottles, carboys, alcoholic drink bottles, medicine bottles or bottles for cosmetic products, dishes, for example for ready-made meals or microwave dishes, or also lids. These receptacles can be of any size.

The article may for example be suitably manufactured by extrusion-blow moulding, thermoforming or injection-blow moulding.

The present invention therefore also conveniently provides a method for manufacturing an article, comprising the use of one or more polyester (co)polymers according to the invention and preferably comprising the following steps: 1) the provision of a polyester (co)polymer obtainable by or obtained by the process of this invention; 2) melting said polyester (co)polymer and optionally one or more additives and/or one or more additional polymers, to thereby produce a polymer melt; and 3) extrusion-blow moulding, thermoforming and/or injection-blow moulding the polymer melt into the article.

The article can also be manufactured according to a process comprising a stage of application of a layer of polyester in the molten state to a layer based on organic polymer, on metal or on adhesive composition in the solid state. This stage can be carried out by pressing, overmoulding, lamination, extrusion-lamination, coating or extrusion-coating.

Advantageously, the carbonate polyester (co)polymers produced according to the process of the invention can be used in 3D printing. In case very high molecular weights are desired, the use of alternative types of reactors could potentially be a solution, such as extruders and compounders that are known to be used with polymers produced with several types of chain extenders. For example, a spinning disk reactor is highly suitable for processing highly viscous polymers.

### BRIEF DESCRIPTION OF THE DRAWINGS

FIG. 1. Tensile strength of PISC and other polymers. Commercial ABS (Terluran GP-35) was processed in a similar manner as the PISC and PISO tensile bars. Also commercially obtained tensile bars of Eastman Tritan (copolyester TX1001) were tested. Tests are averages of at least 3 samples, and their standard deviation is given by the error bars.

FIG. 2. Young's modulus and elongation at break of PISC and other polymers. Commercial ABS (Terluran GP-35) was processed in a similar manner as the PISO tensile bars. Also commercially obtained tensile bars of Eastman Tritan (copolyester TX1001) were tested. Tests are averages of at least 3 samples, and their standard deviation is given by the error bars. For the elongation at break the maximum found value was taken.

The invention is further illustrated by the following non-limiting examples.

### EXAMPLES

List of abbreviations
BnSnOOH=butyltin hydroxide oxide hydrate
DCM=dichloromethane
DEG=diethylene glycol
DGC=diguaiacyl carbonate
DPC=diphenyl carbonate
GPC=gel permeation chromatography
ISO=isosorbide
OP=oxygen permeability
PDI=polydispersity index
PISA=poly(isosorbide succinate)
PISC=poly(isosorbide succinate co-carbonate)
PISO=poly(isosorbide succinate co-oxalate)
PISOX=poly(isosorbide oxalate)
PrDO=1,3-propanediol
RPM=rotations per minute
SSP=solid state polymerization
TCE=tetracholoroethane
TEA=triethylamine
THF=tetrahydrofuran
TGA=thermographic analysis
TPA=terephthalic acid
WVP=water vapor permeability

### Materials

Guaiacol (99%) and isosorbide (98%) were purchased from Carbosynth. Diguaiacylcarbonate (>98%) was bought from TCI chemicals. Succinic acid (99%) and the Universal Indicator (HoneyWell Fluka) were obtained from Fisher scientific. Tetrahydrofuran (99%), dichloromethane (99%), diethyl ether (99%), sodium bicarbonate (99.5%), sodium sulfate (99%; anhydrous), sodium chloride (>99%) were supplied by VWR International. Butyltinhydroxide-oxide was obtained from Sigma. TCE-d2 (99.5%) and DMSO (99.8%) were ordered from ABCR chemicals. Except for isosorbide, all chemicals were used as received. Isosorbide was purified in-house.

### Materials-Isosorbide Purification

High purity isosorbide is required for polymerizations. However, despite being commercially produced, isosorbide of sufficient purity is not readily available. Therefore the commercially obtained isosorbide had to be purified. First, the isosorbide was crystallized from acetone, followed by a distillation step over sodium borohydride. The quality was assessed by ¹H NMR and DSC purity analysis (>99.5%). However, a better lead for assessing the quality of the isosorbide was the polymerization itself. The commercial isosorbide gave a brittle and strongly colored polymer, indicating bad quality. After the crystallization step the color and quality of the polymer improved significantly. Literature sources suggested doing a distillation step over sodium borohydride [Garaleh M, et al. Macromol. Chem. and Phys. 2010; 211(11):1206-1214.] This step was found to be beneficial to improve the color of the final polymer. 1.6 Kg of isosorbide (Carbosynth) was dissolved in hot acetone (600 mL). The slightly yellow transparent solution was then transferred to a 2 L 1-neck flask. The solution was left to cool to R.T. and left overnight to crystallize. The next day, the solution was placed in a freezer (−20° C.) for 2 more days to continue crystallizing. After crystallization, the left over liquid was decanted off and the crystals were washed with 2× ethyl acetate (300 mL). At this stage there was 1257 g (78.6%) of isosorbide left in the flask. Next, 7 g 0.5% (w/w) of NaBH₄ was added. A long path distillation was set up. The flask was slowly heated by an oil bath (100° C.). Then vacuum was slowly applied to the distillation setup. When bubbling came to a minimum the temperature was slowly increased to 175° C. Isosorbide distilled over at 175° C. oil temperature and 0.3 mbar. The received isosorbide had a faint yellow glow as a liquid, but as a solid was completely white, yield 874 g (55%). The residue had a dark brown color (383 g).

### Characterization

### NMR

¹H-NMR and ¹³C-NMR spectra were recorded at appropriate frequencies on a Bruker AV 300 (1H, 300.10 MHz), a Bruker DRX300 (1H, 300.13 MHz), a Bruker AMX 400 (1H, 400.13 MHz) and a Bruker DRX 500 (1H, 499.91 MHz) spectrometers. Chemicals shift are referenced to residual proton in the specified solvent.

### DSC

Differential scanning calorimetry thermograms were obtained with a Mettler Toledo DSC 3 STAR^{e} system. Around 5 mg of sample was weighed in a standard aluminum crucible (40 μl). Next the sample was analyzed in three steps, under a nitrogen flow of 50 ml*min⁻¹. First, after stabilizing at 20° C. for 5 minutes, the sample was analyzed at a rate of 10° C.*min⁻¹ from 20-230° C. Second, the sample was cooled down to the starting temperature of 20° C. with a cooling rate of 50° C.*min⁻¹. Lastly, the first step is repeated, and the data of this cycle is used for reporting.

### TGA

Thermogravimetric analyses were obtained by a Mettler Toledo TGA/DSC 3 STAR^{e} system. Around 15 mg of sample was weighed in an aluminum crucible (100 μl). Next the sample was analyzed at a heating rate of 10° C.*min⁻¹ from 20-550° C. under a nitrogen flow of 50 ml*min⁻¹.

### GPC

Molecular mass distributions were measured using size exclusion chromatography (SEC) on a 1260 Agilent GPC System with two PLgel 5 μm MIXED-C columns (Polymer Laboratories) in series and a 1260 Infinity II refractive index detector, with polystyrene standards and using dichloromethane as mobile phase at 1 mL/min and T=35° C.

### Procedure Compression Molding Films

Films used for barrier measurements were prepared by compression molding with the help of a thermal press (Carver Auto Four/3015-NE,H). Granulates of the polymer are dried in a vacuum oven overnight at 60° C. 2 mbar. A press shape (20*20 cm) is prepared by folding a long piece of aluminum foil 3 times to get 8 layers thick aluminum foil. Half a circle with a diameter of 10 cm is cut out of the foil. The foil is then folded open once to get a circle with a diameter of 10 cm and 4 layers thickness (˜0.1 mm). The aluminum foil press shape is then pre-pressed (10 Forcetons) in between two sheets of Teflon (20*20*0.14 cm) and two aluminum plates (20*20*3 cm). The sandwich is opened and 1.5 grams of polymer is transferred to the middle of the press shape. The polymer is pre-molten by placing the sandwich in the hot press at 190° C. for 2 minutes without pressing. Then the sandwich is pressed at 0.5 tons for 1 minute, 1 tons for 30 seconds, 2 tons for 30 seconds, 5 tons for 30 seconds, and 10 tons for 30 seconds. The sandwich is then removed from the press. The Teflon sheet with the polymer and press shape is separated from the sandwich and left to cool at a flat cold surface. When cooled down the pressing shape and Teflon sheets are removed to obtain the polymer film (˜100 μm). Multiple films were made and visually examined for bubbles and defects. The best film was selected for barrier measurements.

Barrier Measurements Oxygen and water barrier measurements were performed on a Totalperm (Permtech s.r.I) instrument. Calibration of the system was carried out with a standard PET film provided by Permtech (Italy), according to the ASTM F1927-14 standard.

### Injection Molding

Tensile bars were obtained with a Thermo Scientific HAAKE Minijet II apparatus equipped with an ISO-527-2-A5 mold. The pressure, cylinder temperature and mold temperature was set to the corresponding values (see supporting info). When reached, it was made sure the cylinder is clean from any previous runs. The mold is coated with water-based silicon mold release agent, and when dry, placed in the holder. Next 2.2-2.7 grams of polymer was weighed and transferred inside the cylinder. The polymer was left to melt for 2:00 min inside the cylinder. Then the cylinder was placed on top of the mold, door is closed, and the injection program is started. The mold is taken apart, and the sample is removed and examined for defects. The left over polymer is discharged, and the sample is taken from the mold. A typical polymer tensile bar (ISO-527-2-A5) weighed 1.8 gram.

### Tensile Testing

The tensile bars were analyzed on an Instron 5565 machine with load cell (10 kN) and Instron strain gauge extensometer 2630-106 (25 mm). Sample size are set to width (4 mm), thickness (1.95 mm), parallel length (25 mm) and test speed (5 mm/s). When the maximum elongation of the extensometer was reached (100%) the extension of the frame was used to determine the elongation at break.

### Filament Making

The filament was made on a Precision 350 filament maker from the company 3Devo. The following settings were used: Heater 1 (135° C.), 2 (140° C.), 3 (140° C.), 4 (135° C.), screw speed (3.5 RPM), fan speed 15% and filament diameter 2.85 mm.

### Example 1

### PISC Copolymers, Using DGC.

For the preparation of PISC-copolymers a two-step procedure was followed. In the first step isosorbide-succinate oligomers were synthesized. The oligomer synthesis step was complete when all of the water forming reactions were completed. This was indicated by the absence of acid and anhydride groups.

Step 1—In a typical polymerization, a 100 mL three neck round bottom flask was charged with isosorbide (1 eq), succinic acid (0.5 to 0.95 eq), butyltinhydroxide-oxide (2.5*10⁻⁴ eq) and guaiacol (0.75 eq). The amount of succinic acid was added according to the desired succinate content of the polymer. The roundbottom flask was put in an oil bath and equipped with a mechanical stirrer, nitrogen inlet and short path connected Schlenk flask, all suited for high vacuum. Nitrogen flow was set to 50 mL/min and the temperature of the oil bath was set to 238° C. The set temperature was reached in about 30 minutes. As soon as a homogeneous melt was observed the stirring speed was set to 100 RPM. The reaction is complete when there are predominantly (i.e. alcohol to acid ratio of at least 95:5) only hydroxy end groups left (thus, the end groups mainly consist of isosorbide), and varies depending on the succinate content, i.e. 3 hours is at least needed for the 0.5 equivalent.

Step 2—When complete, DGC was added to the reaction mixture so that the diol content equaled the acid ester. The reaction mixture was stirred under a nitrogen flow at a temperature of 230-240° C. for 30 minutes. Next, guaiacol was removed by applying vacuum and increasing the temperature. Typically, the free guaiacol is removed over the course of 1 hour, depending on the scale. Lastly, full vacuum (<1 mbar) was applied for 2 hours at the melting temperature of the polymer, typically around 230-240° C.

Using the two-step synthesis strategy described here, several PISC copolymers were synthesized. The resulting polymers were analyzed for their molecular weight, molar composition and thermal properties, see Table 1.

### Pisc-50% (Detailed)

Oligomer synthesis—3.968 g of Succinic acid (33.6 mmol; 0.51 eq), 9.543 g of Isosorbide (65.3 mmol; 1 eq), 6.3 g of guaiacol (51 mmol; 0.77 eq) and 6 mg of butyltinhydroxide-oxide (4.4*10-4 eq) was weighed in a 100 mL 3-neck roundbottom flask. The roundbottom flask was put in an oil bath and equipped with a mechanical stirrer, nitrogen inlet and short path connected Schlenk flask, all suited for high vacuum. Nitrogen flow set to 50 mL/min and temperature of the oil bath was set to 238° C. The set temperature was reached in about 30 minutes. As soon as a homogeneous melt was observed the stirring speed was set to 100 RPM.

Polymerization—After 5 hours of oligomer synthesis, 8.70 g of DGC (31.7 mmol; 0.49 eq) was added to the reaction flask. After 60 minutes of stirring at 238° C., vacuum was applied. The pressure was reduced until guaiacol slowly came over (˜200 mbar). After around 30 minutes, full vacuum was applied (˜1 mbar), and was maintained while stirring for 60 minutes at 238° C. Then vacuum was replaced by a nitrogen atmosphere, and the polymer was taken out for further analysis.

TABLE 1
Molecular composition, molecular weight and thermal properties of the PISC polymers. The molecular
weights are determined by GPC and ¹H-NMR. The thermal properties are determined by DSC and TGA.

| | | Analysis method-> | | | | | | | | |
|---|---|---|---|---|---|---|---|---|---|---|
| | | Feed | NMR | | | | | | | |
| | | Carbonate | Carbonate | NMR | GPC | GPC | GPC | DSC | TGA | TGA |
| | | content | content | Mn | Mn | Mw | PDI | Tg | T_{d-5%} | T₍₀₎ |
| Sample | Catalyst | (mol %) | (mol %) | (kg/mol) | (kg/mol) | (kg/mol) | (Mw/Mn) | (° C.) | (° C.) | (° C.) |
| PISC | Sn | 48.5 | 47.8 | 24 | 41 | 82 | 1.99 | 114 | 334 | 365 |
| 50% | | | | | | | | | | |
| (DGC) | | | | | | | | | | |
| PISC | Sn | 37.6 | 36.5 | 24 | 19 | 40 | 2.1 | 103 | n.d. | n.d. |
| 37.5% | | | | | | | | | | |
| (DGC) | | | | | | | | | | |

Sn = butyltinhydroxide-oxide (2.5*10⁻⁴ eq), Gua = Guaiacol (~0.75 eq), n.d. = Not determined.
1. T_{d-5%} is the temperature where 5% of the initial mass was lost.
2. T₍₀₎ is the extrapolated onset temperature (maximum thermal degradation rate) calculated by the software.

Although the presence of carbonate units may decrease the thermal stability of the polymer, the thermal stability of the PISC is still well above the temperatures needed for polymerization and processing, likely causing no problems for most common applications (see TGA data in Table 1).

### Example 2

PISC-50% with DPC

Oligomer synthesis—4.014 g of Succinic acid (34.0 mmol; 0.47 eq), 10.550 g of Isosorbide (72.2 mmol; 1 eq), 6.33 g of guaiacol (51 mmol; 0.71 eq) and 7 mg of butyltinhydroxide-oxide (4.7*10⁻⁴ eq) was weighed in a 100 mL 3-neck roundbottom flask. The roundbottom flask was put in an oil bath and equipped with a mechanical stirrer, nitrogen inlet and short path connected Schlenk flask, all suited for high vacuum. Nitrogen flow set to 50 mL/min and temperature of the oil bath was set to 238° C. The set temperature was reached in about 30 minutes. As soon as a homogeneous melt was observed the stirring speed was set to 100 RPM.

Polymerization—After 5 hours of oligomer synthesis, 8.18 g of DPC (38.2 mmol; 0.53 eq) was added to the reaction flask. After 60 minutes of stirring at 238° C., vacuum was applied. The pressure was reduced until phenol/guaiacol slowly came over (˜200 mbar). After around 30 minutes, full vacuum was applied (˜1 mbar), and was maintained while stirring for 45 minutes at 238° C. Then vacuum was replaced by a nitrogen atmosphere, and 10.5 g of polymer was taken out for further analysis. Results in Table 2.

TABLE 2
Molecular composition, molecular weight and thermal properties of the
PISC-50 polymer prepared with DPC. The molecular weight was determined by GPC
and ¹H-NMR. The thermal properties were determined by DSC.

| | | Analysis method-> | | | | | | |
|---|---|---|---|---|---|---|---|---|
| | | Feed | NMR | NMR | GPC | GPC | GPC | DSC |
| | | Carbonate | Carbonate | Mn | Mn | Mw | PDI | Tg |
| Sample | Catalyst | content (mol %) | content (mol %) | (kg/mol) | (kg/mol) | (kg/mol) | (Mw/Mn) | (° C.) |
| PISC | Sn | 52.9 | 51.1 | 13 | 17 | 36 | 2.17 | 114 |
| 50% | | | | | | | | |
| (DPC) | | | | | | | | |

Sn = butyltinhydroxide-oxide (2.5*10⁻⁴ eq), n.d. = Not determined.
Note:
PISC-50% obtained in this Example has a significantly lower Mn (17 kg/mol) than in Example 1 (41 kg/mol), demonstrating an advantage of using DGC when compared to DPC.

### Example 3

### Larger Scale Synthesis of PISC37.5

To explore the potential of scaling up the synthesis strategy, a larger scale reaction (˜425 g of theoretical yield) of PISC (37.5%) was performed in a 2 L Buchi Autoclave. The first day, succinic acid and isosorbide were reacted to form oligomers at 238° C. oil temperature, which took around 4 hours. The second day of this experiment, the calculated DGC was added to the reactor and vacuum was applied at an oil temperature of 220-240° C. After around an hour of full vacuum no increase in torque was observed, which indicates that there is no further chain growth of the polymer. Small portions of DGC were subsequently fed to the reactor, and the torque again increased after each addition. The steep increase after each addition of DGC to a viscous polymer mixture, showed the high reactivity of DGC. After several additions of DGC a high torque (>1000 Ncm) was reached, indicating a high molecular weight polymer was obtained. Next, the polymer was extruded and further analyzed. The total amount of polymer collected was 300 g (71% yield). The NMR showed that the polymer composition was 63.5% succinic acid, 36.5% carbonate and 100% isosorbide with a molecular weight of 23.8 kDa. The Tg of the polymer was 103.4° C., determined by DSC. GPC analysis determined the Mn to be 19 kDa and Mw 40 kDa.

### 3D Printing

The obtained PISC resin was further processed with a desktop sized filament maker of the company 3Devo to produce 2.85 mm filament. This filament was used on a Ultimaker 3 Extended to print a 3D benchy.

### Example 4

### Barrier Properties of PISC

Several PISC copolymers were processed into a film of 100 μm. The films were tested for their oxygen and water barrier under different conditions. The water transmission rate was tested at 90% relative humidity 38° C. and the oxygen transmission rate at 0% and 50% relative humidity at 30° C.

PET has relatively good barrier properties, and is therefore commonly used as packaging material for food and household applications. By comparing the barrier properties of PISC to PET, an impression can be given of its potential as packaging material. The barrier properties also depend on the way the material is processed into a film e.g.: compression molding, film stretching and solution casting. Stretching is the most common method for PET. However, as PISC copolymers are amorphous, to have a proper comparison between the materials, the commercial PET was processed in the same way, in this case by compression molding. When comparing PISC to PET, it appeared that the oxygen barrier is 5 to 8 times better, depending on the relative humidity. However, the moisture barrier of PISC is almost 3 times lower than that of PET.

After converting the transmission rate to permeability, the barrier properties can be compared to literature values (Table 2). The reported permeability of the present experiment show to be similar to the reported values of PET, indicating good reliability of the method used.

Currently there are limited biobased polymers which are biodegradable and possess good mechanical and barrier properties at comparable levels as traditional petroleum-based plastics. When comparing the permeability of PISC with other commercially available biodegradable biobased polymers such as PLA and PBAT, it can be seen that PISC has a considerable lower OP, 23× lower than that of PLA and 76× lower than that of PBAT. The WVP is also lower, 1.7× for PLA and 6.2× for PBAT. Therefore, PISC may potentially be useful for packaging where good oxygen barrier is needed such as in modified atmosphere packaging, meat and cheese packaging.

TABLE 2
Overview of the (in-house) measured films and literature reported values.

| | | | | | |
|---|---|---|---|---|---|
| | OP | | WVP | | |
| | [(cm³ · μm)/(m² · 24 h · | | [(g· μm)/(m² · 24 h · | | |
| Type of film | atm)] | Factor | kPa)] | Factor | OP/WVP |

-experimental measurements-

| | | | | | | | |
|---|---|---|---|---|---|---|---|
| PISC-50 | 927 (30° | C.: 50%) | 1.0 | 722 (38° | C.: 90%) | 1.0 | 1.3 |
| PET (amorphous) | 4,720 (30° | C.: 50%) | 5.1 | 253 (38° | C.: 90%) | 0.4 | 18.7 |
| PET (Oriented) | 1311 (23° | C.: 50%) | 1.4 | 95 (38° | C.: 90%) | 0.1 | 15.2 |

-literature-

| | | | | | | | |
|---|---|---|---|---|---|---|---|
| PISOX | 247 (23° | C.: 50%) | 0.3 | — | | — | — |
| PISA | 720 (30° | C.: 50%) | 0.8 | 580 (38° | C.: 90%) | 0.8 | 1.24 |
| PET (amorphous) | 3,940 (30° | C.: 50%) | 4.3 | — | | — | — |
| PET-oriented | 1,680 (25° | C.: 45%) | 1.8 | 80 (38° | C.: 90%) | 0.1 | 21 |
| (mylar) | | | | | | | |
| PBAT (ecoflex) | 70,851 (23° | C.: 50%) | 76 | 4,470 (38° | C.: 90%) | 6.2 | 15.9 |
| PLA | 21,370-23,060 (28° | C.: 50%) | 23 | 1,204 (38° | C.: 100%) | 1.7 | 18-19 |
| Bio-PE | 54,356 (23° | C.: 0%) | 59 | ~76 (38° | C.: 100%) | 0.1 | 715 |

| | | | | | | |
|---|---|---|---|---|---|---|
| PEF (amorphous) | 722 (30° | C.: 50%) | 0.8 | — | — | — |
| PEF (oriented) | ~270 (25° | C.: 0%) | 0.3 | — | — | — |

Mylar [DuPont Teijn films http://usa.dupontteijinfilms.com/wp-content/uploads/2017/01/Oxygen_ And_ Walter_ Vapour_Barrier_Properties_of_Flex_Pack_Films.pdf. Updated 2001. Accessed Feb. 9, 2022], PLA [Flodberg, G. et al. European Polymer Journal. 2015; 63: 217-226], PEF and PET [Wang, J. et al., Journal of Polymer Science Part A: Polymer Chemistry. 2017; 55(19): 3298-3307], PBAT [Wu, Feng 2021; 222 Qin, Pengkai 2021], Bio-PE [Wu, F. et al. Progress in Polymer Science. 2021; 117: 101395], PEF-Oriented [van Berkel, J. G. On the physical properties of poly (ethylene 2,5-furandicarboxylate) DOI: 10.13140/RG.2.2.23466.16323], PISOX [Kurachi, K. et al. WO2005103111] and overview of others [Wang, J. et al. 2018 ACS Sustainable Chemistry & Engineering. 2018; 6(1): 49-70].

### Example 5

### Mechanical Properties of PISC

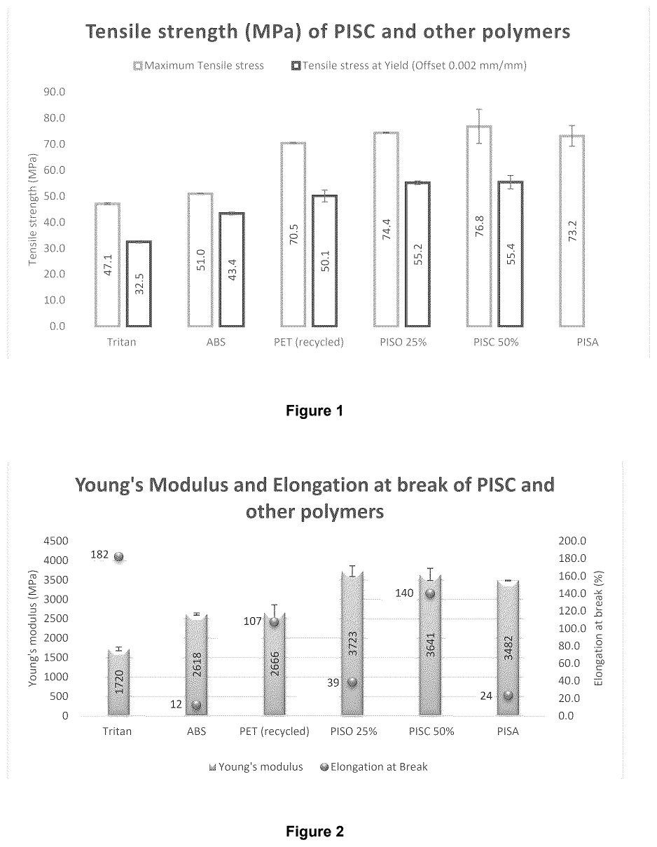

PISC50 was further processed into several tensile bars and their tensile properties were analyzed. The tensile strength and yield strength are shown in FIG. 1. The elongation at break and Young's modulus are shown in FIG. 2. To validate the reliability of the results, PISO (see EP22204847) and commercial ABS (Terluran GP-35) were processed in a similar manner as the PISC tensile bars, and compared to the provided technical data sheet. Also, commercial Eastman Tritan (copolyester TX1001), and PET tensile bars were tested, and compared to their reported values.

With a ultimate tensile strength of 74 to 77 MPa and a yield strength of 55 MPa, PISC polymers show to have good tensile properties. PISC has significant higher tensile and yield strength than the engineering polymers Tritan and ABS. Interestingly, there are only small difference in tensile strength observed between PISO and PISC. Replacing succinate with oxalate or carbonate does not seem to influence the tensile and yield strength noticeably. Also, both PISO and PISC have tensile strengths similar to that of the polymer of succinic acid and isosorbide (PISA, see EP21217721) and the polymers of oxalic acid and isosorbide (PISOX). This likely indicates that the diol, isosorbide, has the major effect on the tensile strength of the polymer. PISO and PISC have a Young's modulus of 3.6-3.7 GPa and are therefore relatively rigid polymers. Compared to Tritan, their Young's modulus is roughly twice as high. Since the tensile modulus of PISA is similar to PISO and PISC, both oxalate and carbonate do not seem to significantly affect the tensile modulus.

With a elongation at break of 140% PISC shows a significantly higher elongation at break than PISO (39%). When comparing to the reported elongation at break for poly isosorbide carbonate (9%) and PISOX (8%), this indicates that succinate provides flexibility, making the material more ductile.

It is known from literature that isosorbide based polymers show relative high tensile strength and modulus. Interestingly, the modulus for PISC is typically higher than reported values. A high tensile modulus could be of added value for protective coatings or packaging end-use performance.

1. A process for the production of a carbonate polyester (co)polymer, comprising the use of bis(2-methoxyphenyl) carbonate to introduce carbonate monomer units into the polymer chain, comprising at least steps (a) and (b):
(a) an esterification/transesterification step wherein at least one dicarboxylic acid or an ester derivative thereof is/are reacted with an excess of at least one diol compound to form a pre-polycondensation product having predominantly alcohol end groups, or otherwise producing such pre-polycondensation product;
(b) a polymerization step comprising polycondensation of the product of step (a) with bis(2-methoxyphenyl) carbonate in a molar amount of at most 0.5 equivalents of the molar amount of alcohol end groups in the pre-polycondensation product of step (a).

2. The process according to claim 1, wherein in step (a) the at least one dicarboxylic acid or an ester derivative thereof is selected from aromatic dicarboxylic acids, heteroaromatic dicarboxylic acids, 1,4-cyclohexanedicarboxylic acid, diglycolic acid or C2-C18—aliphatic dicarboxylic acids which are linear, cyclic or branched.

3. The process according to claim 1, wherein in step (a) the at least one dicarboxylic acid or an ester derivative thereof is selected from succinic acid, adipic acid, 2,5-furandicarboxylic acid or terephthalic acid or an ester derivative of said acid.

4. The process according to claim 1, wherein in step (a) the at least one diol is isosorbide.

5. The process according to claim 1, comprising reacting succinic acid and isosorbide in step (a) to form isosorbide succinate oligomers having predominantly alcohol end groups, wherein a ratio of isosorbide to succinic acid is in the range of 1:0.95 to 1:0.5.

6. The process according to claim 1, comprising adding a monohydric alcohol with a boiling point at ambient pressure of equal to or higher than 175° C. up to equal to or lower than 300° C. and an acid dissociation constant of equal to or less than 12.0 and equal to or more than 7.0, in an amount of 2.5-100 weight % with regard to the total weight of all dicarboxylic acids or ester derivatives thereof and diol compounds together.

7. The process according to claim 6, wherein the monohydric alcohol is an optionally substituted phenol, in particular selected from phenol, 4-methylphenol, 4-ethylphenol, 2-methoxyphenol, 4-methoxyphenol, 4-ethyl-2-methoxyphenol, 4-chlorophenol, or any combination thereof.

8. The process according to claim 1, comprising adding the monohydric alcohol in step (a) of the process.

9. A polyester (co)polymer obtainable by or obtained by a process according to claim 1.

10. A polyester (co)polymer according to claim 9, wherein the polyester (co)polymer is selected from
poly(isosorbide succinate co-carbonate),
poly(isosorbide co-1,3-propylene succinate co-carbonate),
poly(isosorbide co-1,4-butylene succinate co-carbonate),
poly(isosorbide co-cyclohexanedimethylene succinate co-carbonate), or
poly(isosorbide co-diethyleneglycol succinate co-carbonate).

11. A polyester (co)polymer according to claim 9, having a glass transition temperature equal to or higher than 90° C.

12. A polyester (co)polymer according to claim 9, having a number average molecular weight at equal to or higher than 10000 grams/mole.

13. A polyester (co)polymer according to claim 9, wherein the polyester (co)polymer is metal catalyst free.

14. A composition, comprising the polyester (co)polymer according to claim 9, and in addition one or more additives and/or one or more additional other (co)polymers.

15. An article, comprising a composition according to claim 14.
